(19) United States
(12) Patent Application Publication
(10) Pub. No.: US 2025/0244137 A1
(43) Pub. Date: Jul. 31, 2025

(54) METHODS AND SYSTEMS FOR GENERATING HIGH DEFINITION MAP AT A VEHICLE BASED ON A STANDARD DEFINITION MAP

(71) Applicant: Robert Bosch GmbH, Stuttgart (DE)

(72) Inventors: David Fernando PAZ RUIZ, Sunnyvale, CA (US); Yuliang GUO, Palo Alto, CA (US); Hengyuan ZHANG, San Diego, CA (US); Arun DAS, San Jose, CA (US); Xinyu HUANG, San Jose, CA (US); Liu REN, Saratoga, CA (US)

(21) Appl. No.: 18/428,586

(22) Filed: Jan. 31, 2024

(51) Int. Cl. G01C 21/00; B60W 60/00; G01C 21/36; G06V 20/56

(52) U.S. Cl. CPC G01C 21/3804; B60W 60/001; G01C 21/3667; G06V 20/588

(57) ABSTRACT

Methods and systems for generating a HD map and lane trajectory for an autonomous vehicle based on an SD map. Images from one or more image sensors mounted on a vehicle are received. Via a vehicle processor, perception data is generated based on the received images, wherein the perception data provides a representation of an environment proximate to the vehicle. A standard definition (SD) map corresponding with the environment proximate to the vehicle. The vehicle processor generates a high definition (HD) map corresponding with the environment proximate to the vehicle based on the SD map and the perception data. The vehicle processor also generates lane-level trajectory associated with a planned route for the vehicle utilizing the HD map.

### TECHNICAL FIELD

The present disclosure relates to methods and systems for generating high definition (HD) maps at a vehicle (i.e., “online”) based on a standard definition (SD) map.

### BACKGROUND

An autonomous vehicle, often referred to as a self-driving or driverless vehicle, is a type of vehicle capable of navigating and operating on roads and in various environments without direct human control. Autonomous vehicles use a combination of advanced technologies and sensors to perceive their surroundings, make decisions, and execute driving tasks.

Autonomous vehicles are typically equipped with a variety of sensors, including lidar, radar, cameras, ultrasonic sensors, and sometimes additional technologies like GPS and IMUs (Inertial Measurement Units). These sensors provide real-time data about the vehicle's surroundings, including the positions of other vehicles, pedestrians, road signs, and road conditions. The vehicle's onboard computers use data from sensors to create a detailed map of the environment and to perceive objects and obstacles. This information is essential for navigation and collision avoidance.

### SUMMARY

According to an embodiment, a method of generating a HD map and lane trajectory for an autonomous vehicle based on an SD map includes the following: receiving images from one or more image sensors mounted on a vehicle; via a vehicle processor, generating perception data from the received images, wherein the perception data provides a representation of an environment proximate to the vehicle; receiving a standard definition (SD) map corresponding with the environment proximate to the vehicle; via the vehicle processor, generating a high definition (HD) map corresponding with the environment proximate to the vehicle based on the SD map and the perception data; and via the vehicle processor, generating lane-level trajectory associated with a planned route for the vehicle utilizing the HD map.

According to an embodiment, a system for generating a HD map and lane trajectory for an autonomous vehicle based on an SD map includes a plurality of image sensors mounted on a vehicle, and a vehicle processor located on-board the vehicle and in communication with the image sensors. The vehicle processor is programmed to perform the following: generate perception data based on the images, wherein the perception data provides a representation of an environment proximate to the vehicle; receive a standard definition (SD) map corresponding with the environment proximate to the vehicle; generate a high definition (HD) map corresponding with the environment proximate to the vehicle based on the SD map and the perception data, wherein the HD map is generated locally at the vehicle and is not received by the vehicle from a remote server; and generate lane-level trajectory associated with a planned route for the vehicle utilizing the HD map.

According to yet another embodiment, a non-tangible computer readable medium stores instructions that, when executed by a vehicle processor on-board a vehicle, cause the vehicle processor to perform the above.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 shows a schematic diagram of a control system configured to control a vehicle, which may be a partially autonomous vehicle, a fully autonomous vehicle, a partially autonomous robot, or a fully autonomous robot, according to an embodiment.

FIG. 4 shows a schematic overview of a system for generating a high-definition (HD) map and lane-level trajectory based on a standard definition (SD) map and sensor data, according to an embodiment.

FIG. 5 shows a schematic of information provided in an SD map, according to an embodiment.

FIG. 6 shows a method for generating a HD map and lane trajectory for an autonomous vehicle based on an SD map, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Rapid advancements in autonomous driving technology have ushered in a new era of transportation, promising safer and more efficient journeys. Autonomous driving systems generally include three high-level tasks: (1) perception, (2) prediction, and (3) planning. Perception involves the vehicle's ability to understand and interpret its environment. This task includes various sub-components like computer vision, sensor fusion, and localization. Key elements of perception include object detection (e.g., identification and tracking agents external to the autonomous vehicle), localization (e.g., determining the vehicle's precise position and orientation in the world, often using GPS and other sensors), and sensor fusion (e.g., combining data from different sensors, such as cameras, lidar, radar, and ultrasonic sensors to build a comprehensive view of the surroundings). Prediction involves anticipating how other road users and agents in the environment will behave in the near future. This task often involves using machine learning models to estimate the trajectories and intentions of the agents, including pedestrians, other vehicles, and potential obstacles. Accurate prediction is crucial for making safe driving decisions. Planning involves determining the optimal path and actions for the autonomous vehicle to navigate its environment. The planner (also referred to as the planner module or planner model) is an autonomous driving software stack that is responsible for planning the trajectory of the autonomous vehicle. This typically includes tasks like route planning, trajectory planning, and decision-making. The planning system considers information from perception and prediction to make decisions such as when to change lanes, when to stop at an intersection, how to react to unexpected events, and the like.

Autonomous driving applications for urban and highway driving applications often require High Definition (HD) and dense map representations to be able to generate a point-to-point navigation plan. These maps provide detailed and accurate information about the road geometry, lane markings, traffic signs, and other relevant data. Autonomous vehicles use these maps along with real-time sensor inputs to navigate safely and make informed prediction determinations and planning decisions. HD maps are generated off—the vehicle board (i.e., “offline”) and either pre-loaded onto the vehicle's onboard storage system or transmitted wirelessly to the vehicle through communication channels such as 4G, 5G, or other dedicated communication networks. This approach allows for real-time updates and ensures that vehicles have access to the latest map information. However, various challenges arise when maintaining and generating HD maps are at scale. For instance, in heavily dynamic environments and active construction sites, the previously defined maps can be displaced and outdated and as result require continuous updates. The HD map generation and updating tasks often require human labeling and validation teams that present constraints for large scale autonomous driving applications.

To address these limitations, this disclosure proposes building a real-time road network model with all the features provided by offline HD maps to generate HD map representations (e.g., vectorized, rasterized) and reference trajectories on-board the vehicle (i.e., “online”) that can be utilized by downstream planner components. In embodiments, this includes the use of real-time perception data from the vehicle sensors mounted on the vehicle with sparse and lightweight prior maps (SD maps) that are widely available and scalable. This approach is capable of generating lane-level trajectories that can be ingested by behavioral and motion planners.

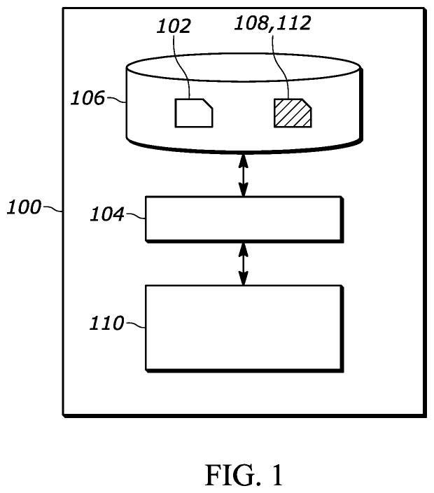

Machine learning and neural networks are an integral part of autonomous vehicles and embodiments of the invention disclosed herein. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106.

The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The system 100 shown in FIG. 1 is one example of a system that may be utilized to train the machine learning models described herein.

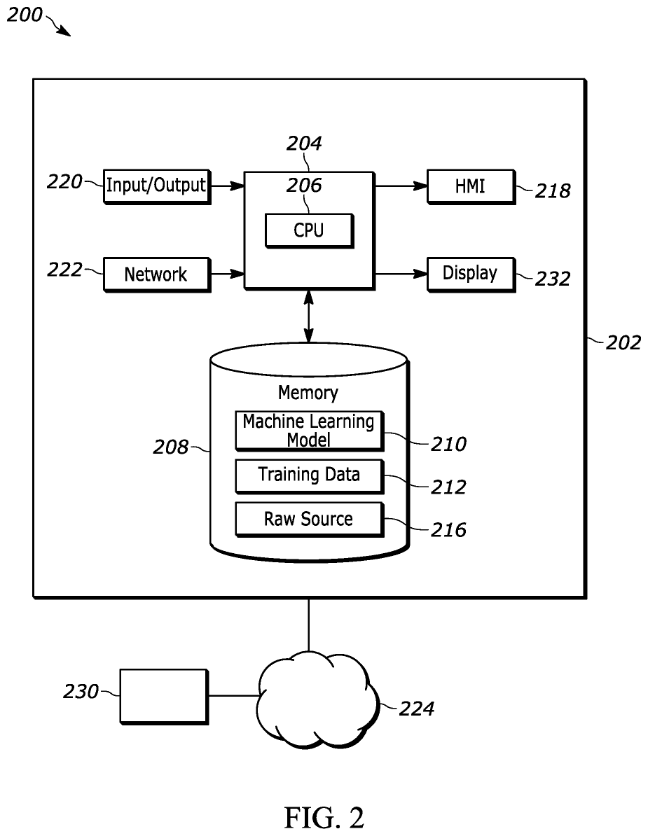

FIG. 2 depicts a system 200 to implement the machine-learning models described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud. This allows for the transmission of SD map data and HD map data to the vehicle, for example (even though as will be explained further below, in embodiments the HD map is generated online at the vehicle rather than transmitted to the vehicle via the network interface device).

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224. These servers 230 may be configured to generate SD map data and HD map data, for example. In embodiments, the SD map is generated by and at the server 230, transmitted via network 224 to a computing system 202 on the vehicle, whereby the computing system 202 on the vehicle creates an HD map and lane trajectories online at the vehicle based on the transmitted SD map and perception data, thereby allowing the HD map to be created online and based on live data rather than being generated at the server 230 and updated therefrom.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, sensors, touch screen, etc. Examples of output devices include monitors, touchscreens, speakers, head-up displays, vehicle control systems, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. The computing system 202 may include a display device 232. The computing system 202 may include hardware and software for outputting graphics and text information to the display device 232. The display device 232 may include an electronic display screen, projector, speaker or other suitable device for displaying information to a user or operator. In the context of a vehicle, the display device 232 may be a touch screen or head-up display for example. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data (e.g., perception data) that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate one or more of the machine learning models described herein.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign, another vehicle, an intersection, etc.). The input images may include various scenarios in which the objects are identified. The input data may also include vectorized SD map definitions represented as graphs, for example.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data. In the context of perception, prediction, and planning models, for each model comparisons can be made between the commanded action of the autonomous vehicle and the outcome based on that commanded action. The models can be trained with an optimizer to reduce this loss (e.g., increase the reward), which can lead to convergence.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of other objects (e.g., other cars, pedestrians, etc.) in video images, annotate the occurrences, and/or command the vehicle to take a specific action (planning) based on the locational data of the detected object (perception) and the predicted future movement/location of the object (prediction). The machine-learning algorithm 210 may be programmed to process the raw source data 216 to identify the presence of the particular features. The machine-learning algorithm 210 may be configured to identify a feature in the raw source data 216 as a predetermined feature (e.g., road sign, pedestrian, etc.). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

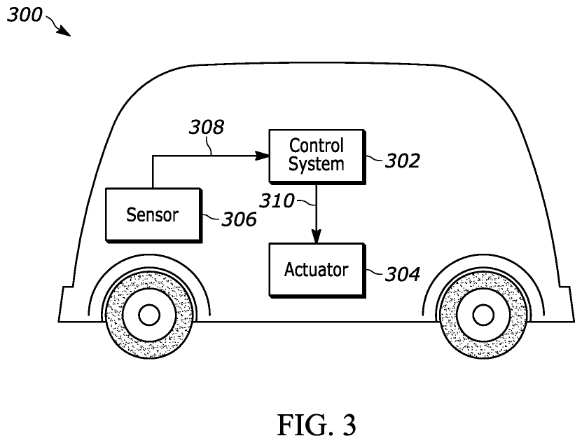

FIG. 3 depicts a schematic diagram of control system 302 configured to control vehicle 300, which may be a partially autonomous vehicle or fully autonomous vehicle, partially autonomous robot or fully autonomous robot. The vehicle 300 and/or its control system 302 can incorporate one or more components of the system 200, such as computing system 202 in order to command an actuator 304 to perform a certain action based upon processing readings from one or more sensors 306. For example, control system 302 can be configured to utilize a planning model in order to control movement of the vehicle via actuator 304, with the planning model being trained via an optimizer. Training can include reinforcement learning as an example.

The one or more sensors 306 may include one or more image sensors (e.g., camera, video sensors, radar sensors, ultrasonic sensors, LiDAR sensors), and/or position sensors (e.g. GPS). The sensors 306 can be configured to generate raw source data 216 indicative of the current state and/or environment associated with the vehicle. One or more of the one or more specific sensors may be integrated into (e.g., mounted, physically connected, etc.) the vehicle 300. In the context of agent recognition and processing as described herein, the sensor 306 is a camera mounted to or integrated into the vehicle 300. Alternatively or in addition to one or more specific sensors identified above, sensor 306 may include a software module configured to, upon execution, determine a state of actuator 304. The data generated from these sensors can be fused or otherwise combined to create a bird-eye-view (BEV) that provides spatiotemporal information associated with the vehicle and the detected agents in the environment.

In embodiments where vehicle 300 is a fully or partially autonomous vehicle, actuator 304 may be embodied in a brake, an accelerator, a propulsion system, an engine, a drivetrain, or a steering system (e.g., steering wheel) of vehicle 300. Actuator control commands may be determined such that actuator 304 is controlled such that vehicle 300 avoids collisions with detected agents, for example. Detected agents may also be classified according to what classifier deems them most likely to be, such as pedestrians or trees. The actuator control commands may be determined depending on the classification.

In other embodiments where vehicle 300 is a fully or partially autonomous robot, vehicle 300 may be a mobile robot that is configured to carry out one or more functions, such as flying, swimming, diving and stepping, via actuator 304. The mobile robot may be an at least partially autonomous lawn mower or an at least partially autonomous cleaning robot. In such embodiments, the actuator control command may be determined such that a propulsion unit, steering unit and/or brake unit of the mobile robot may be controlled such that the mobile robot may avoid collisions with identified objects.

As presented above, this disclosure is directed to the use of real-time perception data from the various sensors 306 on the vehicle along with SD maps to generate HD maps and lane-level trajectories online (by a computing system 202 onboard the vehicle). In embodiments, the computing system 202 onboard the vehicle processes images (e.g., from one or more of a camera, lidar sensor, radar sensor, etc.), as well as vectorized SD map definitions represented as graphs. As a result, the computing system 202 generates, as an output, a graphical representation of the road features, lane boundaries, pedestrian crossings, road edges, surface markings, traffic lights, traffic signals detected, and their corresponding relationships indicated as modeled in the graphical representation. Various attributes can be additionally embedded to each of the entities predicted. For example, a traffic signal that contributes to speed limit constraints can include a speed attribute as well as the lanes it imposes the speed limit on. As another example, a road sign or road marking that indicates which way the traffic in a specific lane is to turn can include a directional attribute as well as the lane it imposes the constraint on.

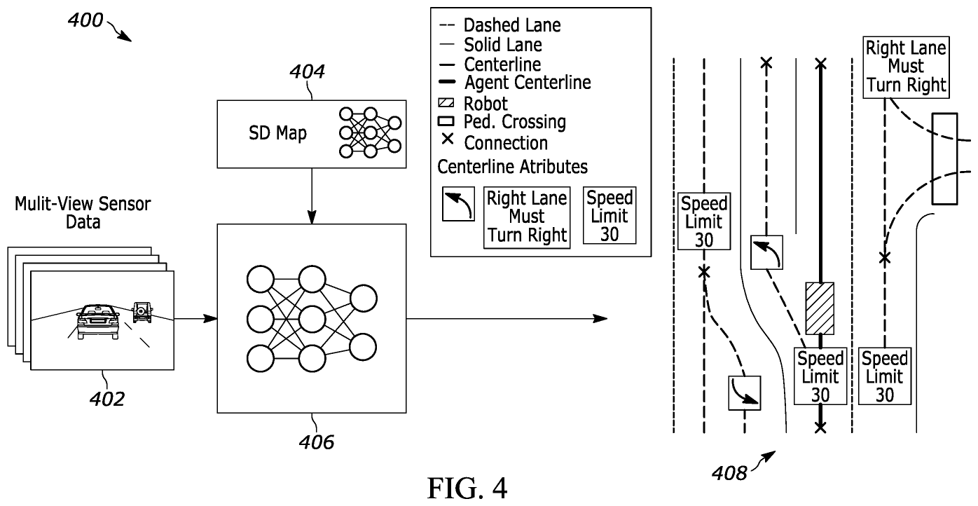

FIG. 4 shows a schematic of a system 400 for generating a HD map and lane trajectory for an autonomous vehicle based on an SD map, according to an embodiment. Sensor data from the vehicle sensors can be captured, as represented at 402. This can include images, lidar, radar, and the like as described above. The sensor data can be perception data associated with an environment outside the vehicle. It can also be multi-view sensor data that allows the vehicle to properly navigate in an autonomous fashion. For example, the multi-view sensor data 402 can allow for the creation of a BEV for performing autonomous driving actions. The sensor data 402 is processed by the on-board vehicle computing system, e.g., computing system 202. Doing so can allow the computing system 202 to determine the presence of pedestrians, road lane markers, other vehicles, traffic signals, and the like.

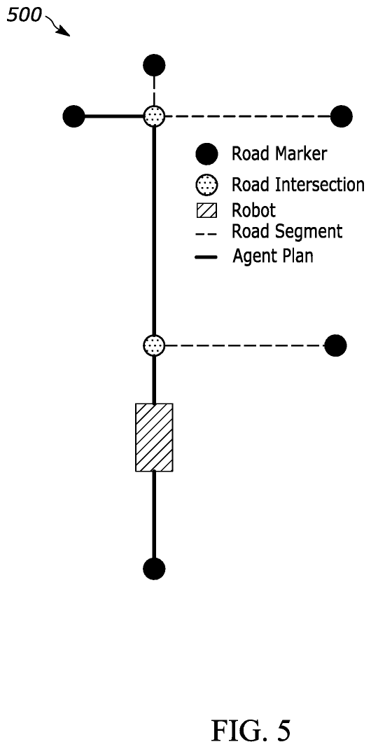

The system can also utilize a learning-based strategy to fuse the sensor data input 402 with SD map representations 404 via a fusion model 406, shown generally at 406. The SD map representations 404 can include a vectorized topological map that describes the coarse road network connectivity and includes high-level information about potential road elements such as intersections. In some embodiments, the SD map data may be vectorized, representing spatial data using vector graphics, including describing the features of a map as geometric objects like points, lines, and polygons, rather than using a raster or pixel-based representation. In other embodiments, the SD map can be rasterized, whereby the raster SD map is an image representation of an SD map. FIG. 5 shows an example of graph-based SD map representations 500 of a three-way intersection that corresponds to the driving scenario of FIG. 4 shown at 408. The SD map data can include basic information about road layout, major landmarks, and general navigation data. The SD map data is typically used in situations where the level of detail provided by HD maps is not essential, such as for traditional navigation systems (e.g., turn-by-turn) in non-autonomous vehicles. However, in examples of the present invention, the SD map data is used to create an HD map online at the vehicle. The SD map may be graph-based in that it represents the road network as a graph with nodes (verticies) and edges. In the context of a road network, the nodes can represent key points such as intersections, junctions, traffic circles, or other significant locations, while edges can represent the connections (roads) between these points. The edges may contain information about the distance, speed limits, or other relevant attributes of the road segment they represent. Navigation and path-planning algorithms can leverage graph traversal techniques to find optimal routes

In an embodiment, the SD map data 500, 404 can be fused with the sensor data 402 at the fusion model 406, and used to generate an HD map, shown generally as an example at 408. The system selects a centerline for the vehicle (e.g., labeled “robot”) that best aligns with the autonomous agent's plan defined by the SD map. In other words, the SD map data may include a general direction on a road-level of where the vehicle should travel, and therefore the created HD map may include a planned trajectory that matches with this road-level direction except on a lane-level. The lane-level trajectory generated can be based on the detected road lane lines, predicted trajectories of other objects, and other perception and prediction model outputs. This allows the on-vehicle computing system to generate its own HD map that allows for real-time map generation of significant lane and traffic constraint features for autonomous driving actions without the need for relying on HD map data to be generated offline and transmitted to the vehicle.

The methods and systems disclosed herein allow operation with minimal priors compared to the state-of-the-art autonomous driving architectures that require HD maps and/or updates to be transmitted to the vehicle. This approach can fuse estimates across time to refine predictions. In contrast to prior methods, embodiments of this invention make use of SD maps to enhance online road estimation performance and identifies centerline trajectories that can be utilized by downstream planner tasks.

SD maps provides a prior on lane topology. The vehicle's computing system then generates a trajectory that best matches what the SD map provides as a prior, but based upon the sensed objects and environment about the vehicle in real-time. The SD map can provide some high-level information about what the road might look like, and the sensor information fills in the gaps so an HD map with a lane trajectory can be generated based on the live sensor data. The lane-level information created can be used by the autonomous navigation system to control driving operation of the vehicle.

It should be understood that the SD map 404 is not required to create the HD map. Instead, the sensor data 402 can be relied upon to create the HD map online at the vehicle, without the need for the SD map. In such an embodiment, a fusion of sensor data 402 with the SD map 404 would not be required, and instead the sensor data 402 (e.g., in the form of perception data) may be utilized to create the lane-level map and lane-level trajectory.

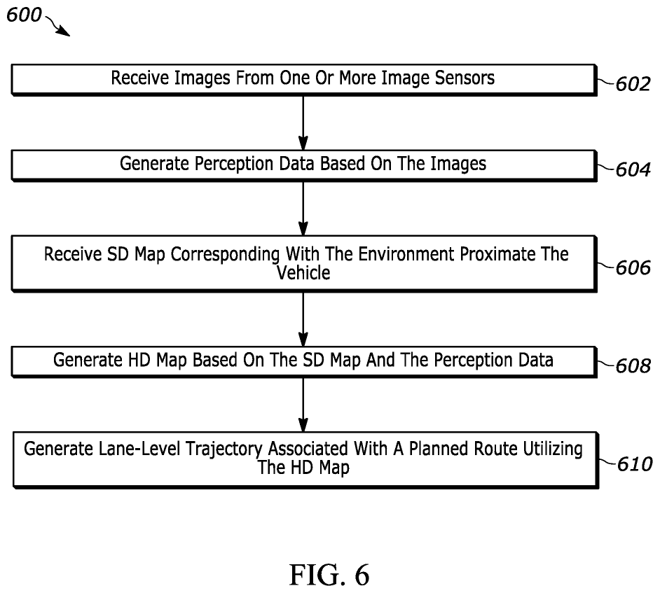

FIG. 6 illustrates a method 600 of generating a HD map and lane trajectory for an autonomous vehicle based on an SD map, according to an embodiment. The method may be performed by a computing system 202, such as an on-board computing system integrated in an autonomous vehicle. At 602, images are received from one or more vehicle sensors. This can include camera images, lidar images, radar images, and/or the data associated with these images or generated from the sensors.

At 604, the computing system onboard the vehicle generates perception data from the received images. The perception data provides a representation of an environment proximate to the vehicle. This can include detected objects in the vicinity of the vehicle. The generated perception data can also include lane lines, traffic signals, road signs, pedestrians, and the like that are generated by the autonomous vehicle's perception model during object detection, localization, and sensor fusion for example.

At 606, the computing system receives a SD map corresponding with the environment proximate the vehicle. SD maps are widely available, scalable, and low cost. SD maps, also known as basic or low-definition maps, provides essential information about the road network but are less detailed compared to HD maps. The level of detail in SD maps is generally sufficient for basic (non-autonomous) navigation and route planning. The SD map can provide a prior on certain road-level information, such as road layout including basic information about road geometry and layout, including the arrangement of streets and intersections. The SD map can also provide identification of key landmarks and points of interest, such as buildings, parks, or significant locations. The SD map can also provide information about natural features like rivers, mountains, and other topographical elements. The SD map can also provide basic data on traffic rules and regulations, such as speed limits, stop signs, and traffic signals. The SD map can also provide basic road-level information such as the number of lanes on a road, along with basic route information to assist the vehicle to find an optimal path from one point to another.

However, the SD map would not include detailed lane-level data, such as attributes specific to each lane. This type of data is important for autonomous driving actions that require granular understanding of the road environment for precise navigation and decision making. For example, the SD map may not include lane geometry (e.g., curvature, slope, boundaries), lane markings (e.g., solid, dashed, color, width), lane changes and merges, lane connectivity (e.g., how lanes connect and transition between different sections of the road network), permissible speeds in each lane, occupancy status of the lanes, traffic signals for each lane, and lane-specific traffic flow information. These are examples of data that are generated on-board the vehicle based on the sensor data, and not provided as a prior such as by the SD map. For example, at 608, the computing system on-board the vehicle generates an HD map online based on the SD map and the generated perception data. The information generated by the computing system for the HD map can include the lane-level information described above that is not provided to the vehicle as a prior.

At 610, the computing system also generates a lane-level trajectory associated with the planned route for the vehicle utilizing the HD map. A lane-level trajectory takes into account the information generated by the computing system for the HD map, described above. For example, the lane-level trajectory includes a planned route for the vehicle based on the lane lines, the traffic signals and other constrictions associated with the individual lanes, and other detected objects in the environment.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, case of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of generating a HD map and lane trajectory for an autonomous vehicle based on an SD map, the method comprising:
receiving images from one or more image sensors mounted on a vehicle;
via a vehicle processor, generating perception data from the received images, wherein the perception data provides a representation of an environment proximate to the vehicle;
receiving a standard definition (SD) map corresponding with the environment proximate to the vehicle;
via the vehicle processor, generating a high definition (HD) map corresponding with the environment proximate to the vehicle based on the SD map and the perception data; and
via the vehicle processor, generating lane-level trajectory associated with a planned route for the vehicle utilizing the HD map.

2. The method of claim 1, wherein the HD map is generated locally at the vehicle and is not received by the vehicle from a remote server.

3. The method of claim 1, wherein the perception data includes lane lines, and wherein the generating the lane-level trajectory includes generating a centerline based on the lane lines, wherein the centerline is associated with the planned route for the vehicle.

4. The method of claim 3, further comprising:
via the vehicle processor, utilizing the centerline in downstream planner tasks.

5. The method of claim 1, wherein the lane-level trajectory is generated based on a prior trajectory provided by the SD map.

6. The method of claim 1, wherein the one or more image sensors includes a lidar sensor.

7. The method of claim 1, further comprising:
executing autonomous driving commands to autonomously navigate the vehicle based on the lane-level trajectory and the HD map.

8. A system for generating a HD map and lane trajectory for an autonomous vehicle based on an SD map, the system comprising:
a plurality of image sensors mounted on a vehicle; and
a vehicle processor located on-board the vehicle and in communication with the image sensors, wherein the vehicle processor is programmed to:
generate perception data based on the images, wherein the perception data provides a representation of an environment proximate to the vehicle;
receive a standard definition (SD) map corresponding with the environment proximate to the vehicle;
generate a high definition (HD) map corresponding with the environment proximate to the vehicle based on the SD map and the perception data, wherein the HD map is generated locally at the vehicle and is not received by the vehicle from a remote server; and
generate lane-level trajectory associated with a planned route for the vehicle utilizing the HD map.

9. The system of claim 8, wherein the perception data includes lane lines, and wherein the generated lane-level trajectory includes a centerline generated based on the lane lines, wherein the centerline is associated with the planned route for the vehicle.

10. The system of claim 9, wherein the vehicle processor is further programmed to utilize the centerline in downstream planner tasks.

11. The system of claim 8, wherein the lane-level trajectory is generated based on a prior trajectory provided by the SD map.

12. The system of claim 8, wherein the plurality of image sensors includes both a camera and a lidar sensor.

13. The system of claim 8, wherein the processor is further programmed to execute autonomous driving commands to autonomously navigate the vehicle based on the lane-level trajectory and the HD map.

14. A non-tangible computer readable medium storing instructions that, when executed by a vehicle processor on-board a vehicle, cause the vehicle processor to perform the following:
receiving images from one or more image sensors mounted on a vehicle;
generating perception data from the received images, wherein the perception data provides a representation of an environment proximate to the vehicle;
receiving a standard definition (SD) map corresponding with the environment proximate to the vehicle;
generating a high definition (HD) map corresponding with the environment proximate to the vehicle based on the SD map and the perception data, wherein the HD map is generated locally at the vehicle and is not received by the vehicle from a remote server; and
generating lane-level trajectory associated with a planned route for the vehicle utilizing the HD map.

15. The non-tangible computer readable medium of claim 14, wherein the perception data includes lane lines, and wherein the generating the lane-level trajectory includes generating a centerline based on the lane lines, wherein the centerline is associated with the planned route for the vehicle.

16. The non-tangible computer readable medium of claim 15, wherein the instructions further cause the processor to perform:
utilizing the centerline in downstream planner tasks.

17. The non-tangible computer readable medium of claim 14, wherein the lane-level trajectory is generated based on a prior trajectory provided by the SD map.

18. The non-tangible computer readable medium of claim 14, wherein the one or more image sensors includes a lidar sensor.

19. The non-tangible computer readable medium of claim 14, wherein the instructions further cause the processor to perform:
executing autonomous driving commands to autonomously navigate the vehicle based on the lane-level trajectory and the HD map.
